(19) United States
(12) Patent Application Publication
(10) Pub. No.: US 2024/0012959 A1
(43) Pub. Date: Jan. 11, 2024

(54) DIGITAL TWIN COOPERATION METHOD, DIGITAL TWIN COOPERATION SYSTEM, AND DIGITAL TWIN COOPERATION PROGRAM

(71) Applicant: Hitachi, Ltd., Tokyo (JP)

(72) Inventors: Atsushi TOMOBE, Tokyo (JP); Ryoji FURUHASHI, Tokyo (JP)

(21) Appl. No.: 18/110,034

(22) Filed: Feb. 15, 2023

(30) Foreign Application Priority Data
Jul. 7, 2022 (JP) 2022-109510

(51) Int. Cl. G06F 30/20

(52) U.S. Cl. CPC G06F 30/20; G06F 2119/02

(57) ABSTRACT

The number of man-hours is reduced for constructing a digital twin with a digital twin cooperation system that causes a business system related to production including product manufacturing to cooperate with a digital twin for simulating the production based on transaction data and model data. The result data related to the production acquired from the business system is converted into the transaction data using the master data and inputting the transaction data into the digital twin. Included are a change detection step of detecting a change in manufacturing information related to the product manufacturing that the business system has; a determination step of determining whether the change is absorbable in the master data based on an existing record of the master data; and an update step of updating the master data or the model data based on the change according to a determination result of the determination step.

### CROSS-REFERENCE TO RELATED APPLICATION

The present application claims priority from Japanese application JP2022-109510, filed on Jul. 7, 2022, the contents of which is hereby incorporated by reference into this application.

### TECHNICAL FIELD

The present invention relates to a digital twin cooperation method, a digital twin cooperation system, and a digital twin cooperation program.

### BACKGROUND ART

In recent years, product life management (PLM) has been performed in a manufacturing industry. In the PLM, information related to each process (planning, design, procurement, processing, assembly, inspection, sale, disposal, etc.) in the life of a product is collected and managed. For example, a PLM system manages a design specification, a bill of material (BOM), a bill of process (BOP), and the like.

Meanwhile, there are an enterprise resources planning (ERP) system that performs accounting management, production management, and order management, and a manufacturing execution system (MES) that manages a production site instruction.

A digital twin that reproduces the production of a product in a virtual space on a computer is generated by utilizing data from a plurality of systems, and the production is simulated by changing conditions such as a place and a time.

### CITATION LIST

### Patent Literature

PTL 1: JP2020-42814A

### SUMMARY OF INVENTION

### Technical Problem

However, in the related art, when the BOM/BOP is changed, systemic data feedback is performed only for design. A change in BOP includes a change in process order, a change in resource, or the like. A change in BOM includes a change in supplier of a part of the product.

The change in BOM/BOP also influences the ERP and the MES. However, when the BOM/BOP is changed, data feedback to the ERP and the MES is manually performed. That is, when the BOM/BOP is changed, it is necessary to manually associate data including the MES/ERP and to change a model in the digital twin, which takes a lot of man-hours.

The invention has been made in view of the above circumstances, and aims to reduce the number of man-hours for constructing the digital twin.

### Solution to Problem

In order to solve the above-described problem, one aspect of the invention is a digital twin cooperation method executed by a digital twin cooperation system that causes a business system related to production including product manufacturing to cooperate with a digital twin for simulating the production based on transaction data and model data. The digital twin cooperation system includes master data of the digital twin. The digital twin cooperation method includes: a data input step of converting result data related to the production acquired from the business system into the transaction data using the master data and inputting the transaction data into the digital twin; a change detection step of detecting a change in manufacturing information related to the product manufacturing that the business system has; a determination step of determining whether the change is absorbable in the master data based on an existing record of the master data; and an update step of updating the master data or the model data based on the change according to a determination result of the determination step.

### Advantageous Effects of Invention

According to the invention, for example, it is possible to reduce the number of man-hours related to the construction of the digital twin.

### BRIEF DESCRIPTION OF DRAWINGS

FIG. 1 is a diagram showing a configuration of an overall system according to an embodiment.

FIG. 2 is a diagram showing an operator master in an MES.

FIG. 3 is a diagram showing operator transaction data in the MES.

FIG. 4 is a diagram showing machine transaction data in the MES.

FIG. 5 is a diagram showing operation instruction data in the MES.

FIG. 6 is a diagram showing BOP order data in PLM.

FIG. 7 is a diagram showing BOP resource data in the PLM.

FIG. 8 is a diagram showing BOM data in the PLM.

FIG. 9 is a diagram showing a supplier master in ETL.

FIG. 10 is a diagram showing an association master of the BOP of the PLM and a process of a digital twin in the ETL.

FIG. 11 is a diagram showing a table association master of a process and a resource in the ETL.

FIG. 12 is a diagram showing alert data in the ETL.

FIG. 13 is a diagram showing transaction data for each product and process in the digital twin.

FIG. 14 is a diagram showing a process order master in the digital twin.

FIG. 15 is a diagram showing a process ID and 4M master in the digital twin.

FIG. 16 is a diagram showing a process master of a digital twin in the ETL.

FIG. 17 is a flowchart showing a change detection process according to the embodiment.

FIG. 18 is a flowchart showing a digital twin model data collection process according to the embodiment.

FIG. 19 is a flowchart showing a changed part and model difference determination and ETL and digital twin master update process according to the embodiment.

FIG. 20 is a diagram illustrating steps S32 to S34 in FIG. 19.

FIG. 21 is a diagram illustrating steps S35 to S37 in FIG. 19.

FIG. 22 is a diagram illustrating steps S38 to S41 in FIG. 19.

FIG. 23 is a flowchart showing an alert transmission process according to the embodiment.

FIG. 24 is a diagram showing a user interface according to the embodiment.

FIG. 25 is a flowchart showing a data input process according to the embodiment.

FIG. 26 is a diagram showing hardware of a computer.

### DESCRIPTION OF EMBODIMENTS

Hereinafter, an embodiment related to a disclosed technique of the present disclosure will be described with reference to the drawings. The embodiment is an example for describing the present application including the drawings. In the embodiment, omission and simplification are appropriately made for clarified description. Unless otherwise limited, each component in the embodiment may be singular or plural.

The same or similar components are denoted by the same reference numerals, and a description of the components that have already been described in the following embodiment may be omitted or may be mainly focused on differences.

When there are a plurality of components having the same or similar function, different suffixes may be attached to the same reference numeral. When it is not necessary to distinguish a plurality of components from one another, the suffixes may be omitted in the description.

In the embodiment, a process performed by executing a program may be described. A computer uses a processor (for example, a central processing unit (CPU) or a graphics processing unit (GPU)) to perform a process determined by the program using a storage resource (for example, a memory), an interface device (for example, a communication port), or the like. Therefore, a subject of the process performed by executing the program may be the processor. Similarly, the subject of the process performed by executing the program may be a controller, a device, a system, a computing machine, or a node including a processor therein. The subject of the process performed by executing the program may be a calculation unit and may be a dedicated circuit that performs a specific process. Here, the dedicated circuit is, for example, a field programmable gate array (FPGA), an application specific integrated circuit (ASIC), or a complex programmable logic device (CPLD).

The program may be installed in a computing machine from a program source. The program source may be, for example, a program distribution server or a computing machine-readable storage medium. When the program source is a program distribution server, the program distribution server may include a processor and a storage resource that stores a program to be distributed, and the processor of the program distribution server may distribute the program to be distributed to another computing machine. In addition, in the embodiment, two or more programs may be implemented as one program, or one program may be implemented as two or more programs.

In the following embodiment, various types of information will be described in a table format, but various types of information may be in a format other than a table format. Various types of masters and various types of data are stored in a predetermined storage area, even if not specified.

In the following embodiment, “AAA” system may be described as having “BBB data”, such as “BBB data of AAA”. However, “BBB data” is data to be input and output by the “AAA” system, and may be stored in a database system different from the “AAA” system.

In the following embodiment, for example, in a configuration of a server that provides a system, illustration and description of general configurations of a processor, a memory, other hardware, and the like will be omitted, and elements and processes related to the technique disclosed in the present application will be mainly illustrated and described.

### Embodiment

### (Configuration of Overall System 1)

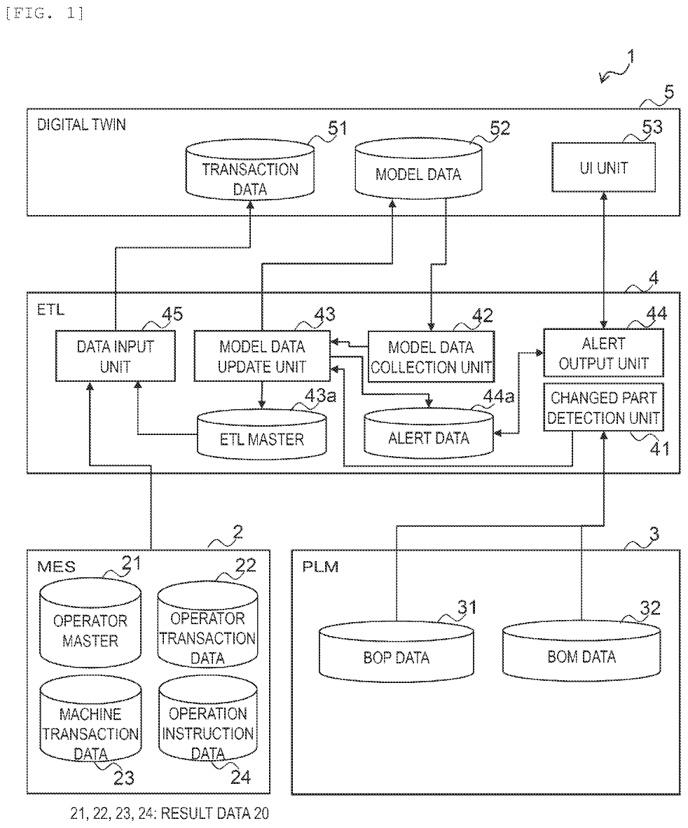

FIG. 1 is a diagram showing a configuration of an overall system 1 according to the embodiment. The overall system 1 includes a manufacturing execution system (MES) 2, product life management (PLM) 3, extract, transform, load (ETL) 4, and a digital twin 5.

MES 2, PLM 3, and ERP (enterprise resources planning, not shown) systems are examples of a business system related to production including product manufacturing. In the present embodiment, production of the product includes, for example, processes of planning, design, procurement, processing, assembly, inspection, sale, and disposal of the product. For example, processing, assembly, and inspection are manufacturing processes.

The MES 2 is a manufacturing execution system, and performs management of the manufacturing processes, gives a process instruction to an operator, and the like. The MES 2 includes an operator master 21, operator transaction data 22, machine transaction data 23, and operation instruction data 24. The operator master 21, the operator transaction data 22, the machine transaction data 23, and the operation instruction data 24 are examples of result data related to the production acquired from the business system.

The operator master 21, the operator transaction data 22, the machine transaction data 23, and the operation instruction data 24 are included in the MES 2. However, the invention is not limited thereto, and the ERP system may include one or more of the master and data. For example, the operation instruction data 24 may be included in the ERP system.

The PLM 3 is a product life management system, and manages information related to a series of processes included in a product life, such as planning, design, production, sale, and disposal of the product. The PLM 3 includes bill of process (BOP) data 31 and bill of materials (BOM) data 32. The BOP data 31 and the BOM data 32 are examples of manufacturing information related to the product manufacturing included in the business system.

The ETL 4 is an example of a digital twin cooperation system that causes the business system to cooperate with the digital twin 5. The ETL 4 is a system having a function of “extracting” data from various databases or data tracks, “transforming” and shaping the extracted data, and “loading” the shaped data to a data warehouse. The ETL 4 includes a changed part detection unit 41, a model data collection unit 42, a model data update unit 43, an ETL master (master data) 43a, an alert output unit 44, alert data 44a, and a data input unit 45. The ETL master 43a is master data used when result data of the MES 2 or the ERP is converted into transaction data 51 of the digital twin 5.

The digital twin 5 is a system that collects, from a real world, data related to life and production of the product, constructs a simulation model of the production of the product in the real world based on the data, and simulates the production and manufacturing of the product on a computer. That is, the digital twin 5 simulates the production based on the business system, transaction data, and model data. The digital twin 5 includes the transaction data 51, model data 52, and a UI unit 53.

### (Operator Master 21 in MES 2)

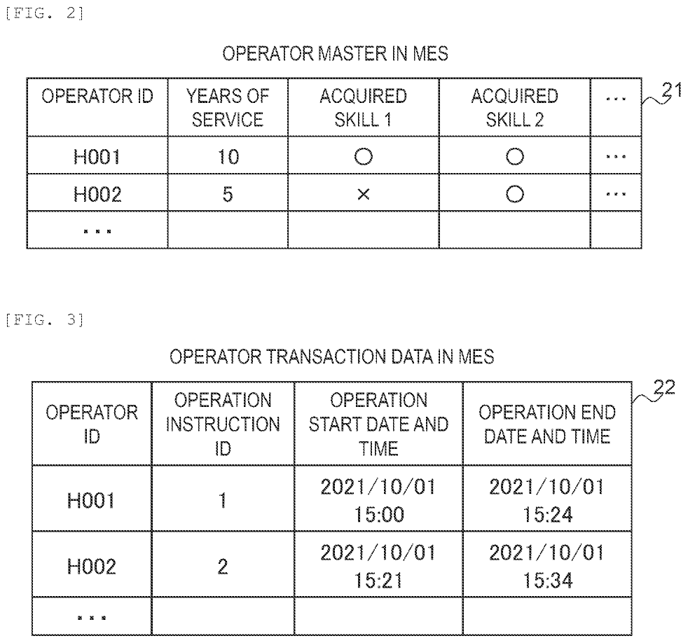

FIG. 2 is a diagram showing the operator master 21 in the MES 2. The operator master 21 has columns of “operator ID”, “years of service”, “acquired skill 1”, “acquired skill 2”, and so on. The “years of service” is the number of years of experience that the corresponding operator has been engaged in an operation. The “acquired skill 1” is information indicating whether the corresponding operator has the “acquired skill 1” related to the operation. The operator master 21 manages attributes related to the operation including operation skills of each operator.

### (Operator Transaction Data 22 in MES 2)

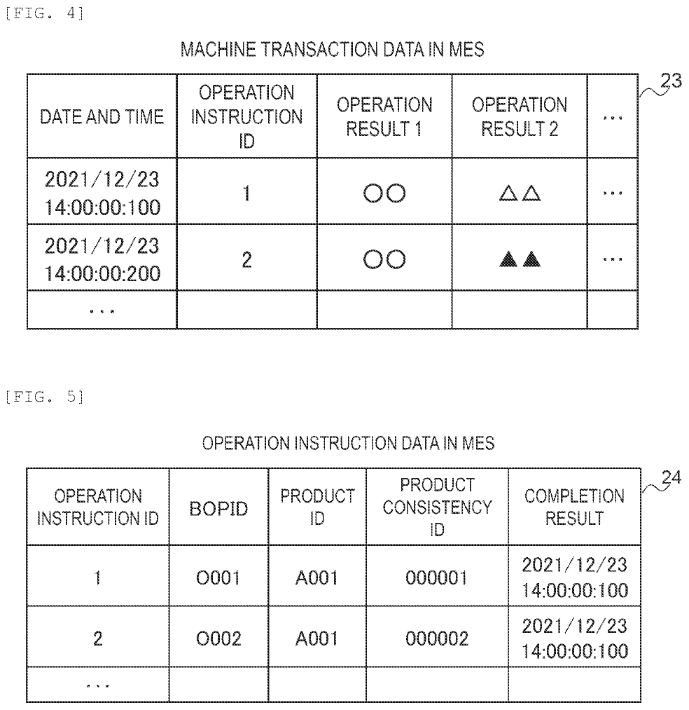

FIG. 3 is a diagram showing the operator transaction data 22 in the MES 2. The operator transaction data 22 is provided for each operator and each operation start and each operation end of a process. The operator transaction data 22 has columns of “operator ID”, “operation instruction ID”, “operation start date and time”, and “operation end date and time”. The operator transaction data 22 is a record indicating that an operator identified by the “operator ID” starts an operation identified by the “operation instruction ID” at the “operation start date and time” and ends the operation at the “operation end date and time”.

### (Machine Transaction Data 23 in MES 2)

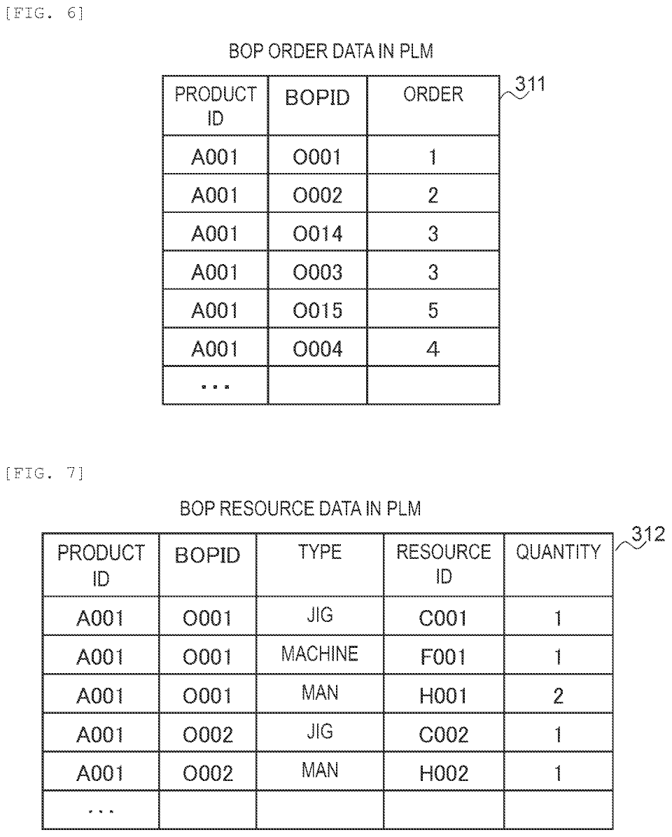

FIG. 4 is a diagram showing the machine transaction data 23 in the MES 2. The machine transaction data 23 relates to a manufacturing machine or a jig at a production site. The machine transaction data 23 is provided for each machine. The machine transaction data 23 has columns of “date and time”, “operation instruction ID”, “operation result 1”, “operation result 2”, and so on. The machine transaction data 23 is a record indicating that the corresponding machine starts an operation identified by the “operation instruction ID” at the “date and time” and achieves a result of various quantities related to the manufacturing indicated by the “operation result 1”, the “operation result 2”, and so on.

### (Operation Instruction Data 24 in MES 2)

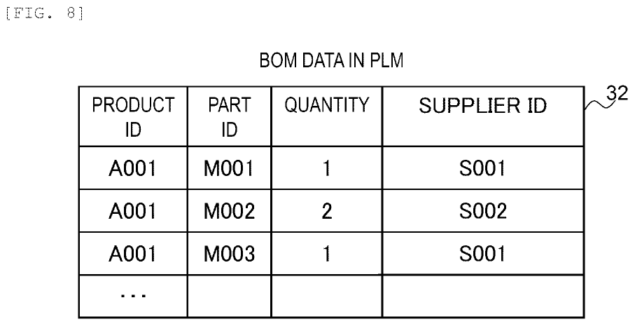

FIG. 5 is a diagram showing the operation instruction data 24 in the MES 2. The operation instruction data 24 has columns of “operation instruction ID”, “BOP ID”, “product ID”, “product consistency ID”, and “completion result”. The operation instruction data 24 is data related to an operation instruction to execute manufacturing of a product identified by the “product ID” to which a product group ID is assigned in the “product consistency ID” according to a BOP identified by the “BOP ID”. The “completion result” is the date and time when the operation based on the corresponding operation instruction is completed.

### (BOP Order Data 311 in PLM 3)

FIG. 6 is a diagram showing BOP order data 311 in the PLM 3. The BOP order data 311 is included in the BOP data 31. The BOP order data 311 has columns of “product ID”, “BOP ID”, and “order”. The BOP order data 311 indicates that a product identified by the “product ID” is manufactured in an order indicated in the “order” according to a BOP identified by the “BOP ID”.

### (BOP Resource Data 312 in PLM 3)

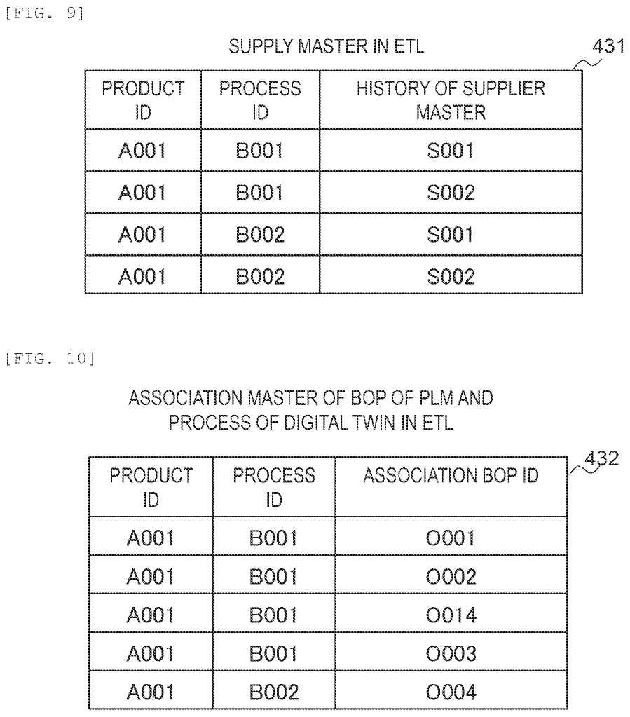

FIG. 7 is a diagram showing BOP resource data 312 in the PLM 3. The BOP resource data 312 is included in the BOP data 31. The BOP resource data 312 has columns of “product ID”, “BOP ID”, “type”, “resource ID”, and “quantity”. The BOP resource data 312 indicates “type”, “resource ID”, and “quantity” of a resource necessary for manufacturing a product identified by the “product ID” according to a BOP identified by the “BOP ID”.

(BOM data 32 in PLM 3)

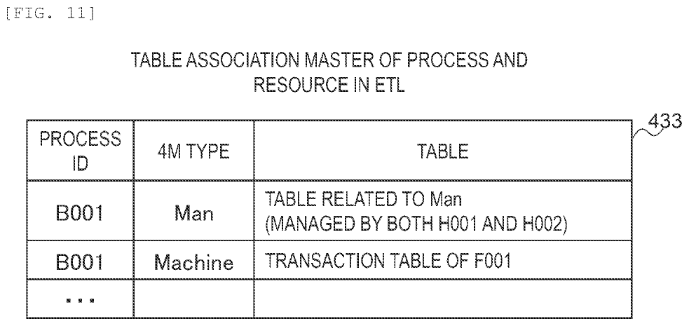

FIG. 8 is a diagram showing the BOM data 32 stored in the PLM 3. The BOM data 32 has columns of “product ID”, “part ID”, “quantity”, and “supplier ID”. The BOM data 32 indicates that a part identified by the “part ID” is required for the “quantity” in order to manufacture a product identified by the “product ID”, and a supplier of the product is identified by the “supplier ID”.

### (Supplier Master 431 in ETL 4)

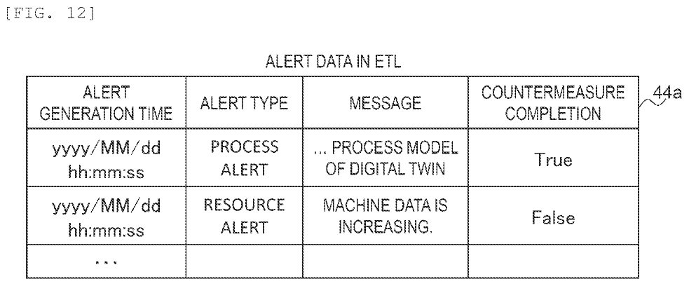

FIG. 9 is a diagram showing a supplier master 431 in the ETL 4. The supplier master 431 is included in the ETL master 43a. The supplier master 431 has columns of “product ID”, “process ID”, and “history of supplier”. The supplier master 431 indicates a supplier ID that has manufactured a product identified by the “product ID” in the past in a process identified by the “process ID”.

### (Association Master 432 of BOP of PLM 3 and Process of Digital Twin 5 in ETL 4)

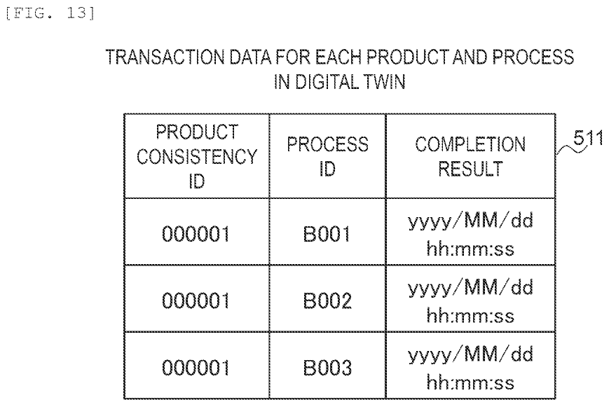

FIG. 10 is a diagram showing an association master 432 of the BOP of the PLM 3 and a process of the digital twin 5 in the ETL 4. The association master 432 is included in the ETL master 43a. The association master 432 has columns of “product ID”, “process ID”, and “association BOP ID”. The association master 432 indicates “BOP ID” associated when a product identified by the “product ID” has been manufactured in the past in a process identified by the “process ID”.

### (Table Association Master 433 of Process and Resource in ETL 4)

FIG. 11 is a diagram showing a table association master 433 of a process and a resource in the ETL 4. The table association master 433 is included in the ETL master 43a. The table association master 433 has columns of “process ID”, “4M type”, and “table”. The table association master 433 indicates a “table” that associates a process identified by the “process ID” with a type of a resource identified by the “4M type”.

### (Alert Data 44a in ETL 4)

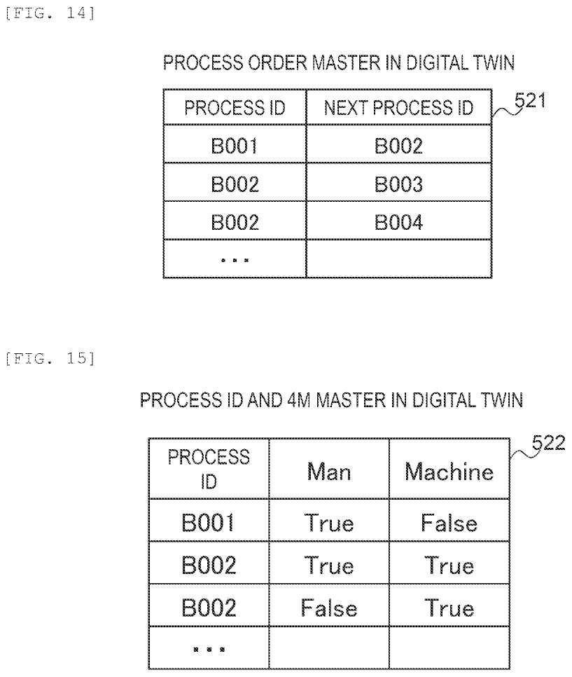

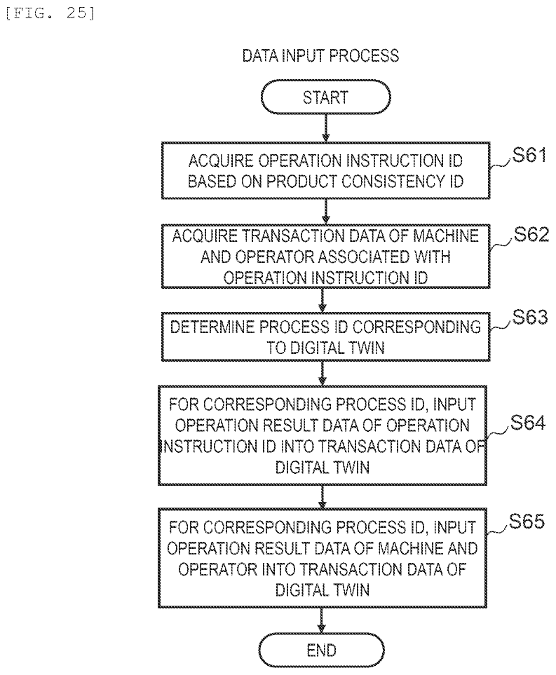

FIG. 12 is a diagram showing the alert data 44a in the ETL 4. The alert data 44a has columns of “alert generation time”, “alert type”, “message”, and “countermeasure completion”. The alert data 44a is displayed on a user interface 53D (FIG. 24) output from the UI unit 53 described later for each record. In an alert that has been coped with by the user using a countermeasure, “countermeasure completion” is “True”.

### (Transaction Data 511 for Each Product and Process in Digital Twin 5)

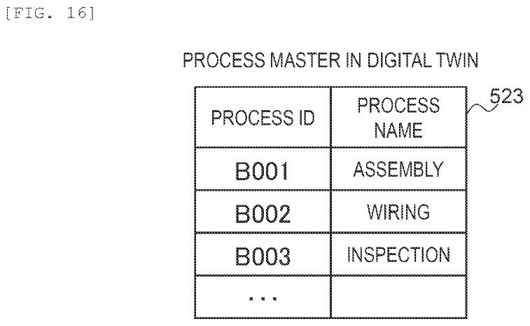

FIG. 13 is a diagram showing transaction data 511 for each product and process in the digital twin 5. The transaction data 511 for each product and process is included in the transaction data 51. The transaction data 511 for each product and process has columns of “product consistency ID”, “process ID”, and “completion result”. The transaction data 511 for each product and process indicates that a process executed on a product of a product group identified by the “product consistency ID” is associated with a result of a completion date and time of the process.

### (Process Order Master 521 in Digital Twin 5)

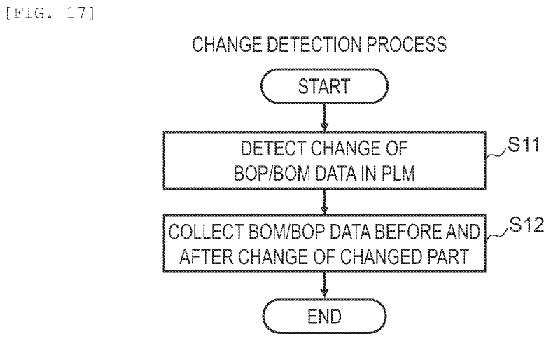

FIG. 14 is a diagram showing a process order master 521 in the digital twin 5. The process order master 521 is included in the model data 52. The process order master 521 has columns of “process ID” and “next process ID”. The process order master 521 indicates the order of the processes.

### (Process ID and 4M Master 522 in Digital Twin 5)

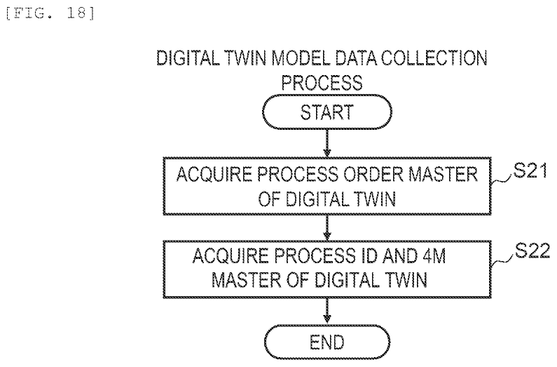

FIG. 15 is a diagram showing a process ID and 4M master 522 in the digital twin 5. The process ID and 4M master 522 is included in the model data 52. The process ID and 4M master 522 has columns of “process ID”, “Man”, and “Machine”. The process ID and 4M master 522 indicates allocation of each resource of “Man” and “Machine” to each process. “True” of “Man” and “Machine” indicates that the corresponding resource is allocated to the corresponding process, and “False” indicates that the corresponding resource is not allocated to the corresponding process.

### (Process Master 523 in Digital Twin 5)

FIG. 16 is a diagram showing a process master 523 of the digital twin 5 in the ETL 4. The process master 523 is included in the model data 52. The process master 523 indicates a “process name” of a process identified by a “process ID”.

### (Change Detection Process)

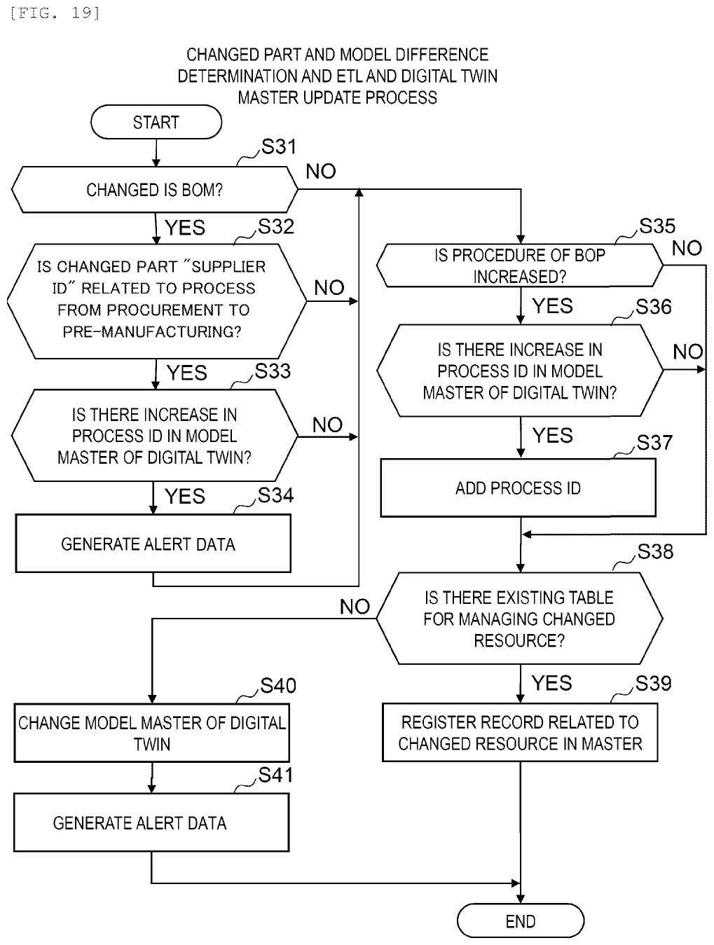

FIG. 17 is a flowchart showing a change detection process according to the embodiment. The change detection process is executed by the changed part detection unit 41 of the ETL 4 at a predetermined cycle or in response to user designation.

First, in step S11, the changed part detection unit 41 detects a change of the BOP data 31 and the BOM data 32 in the PLM 3. Next, in step S12, the changed part detection unit 41 collects the BOP data 31 and the BOM data 32 before and after a change of a changed part, and stores the BOP data 31 and the BOM data 32 in a storage area (not shown).

### (Digital Twin Model Data Collection Process)

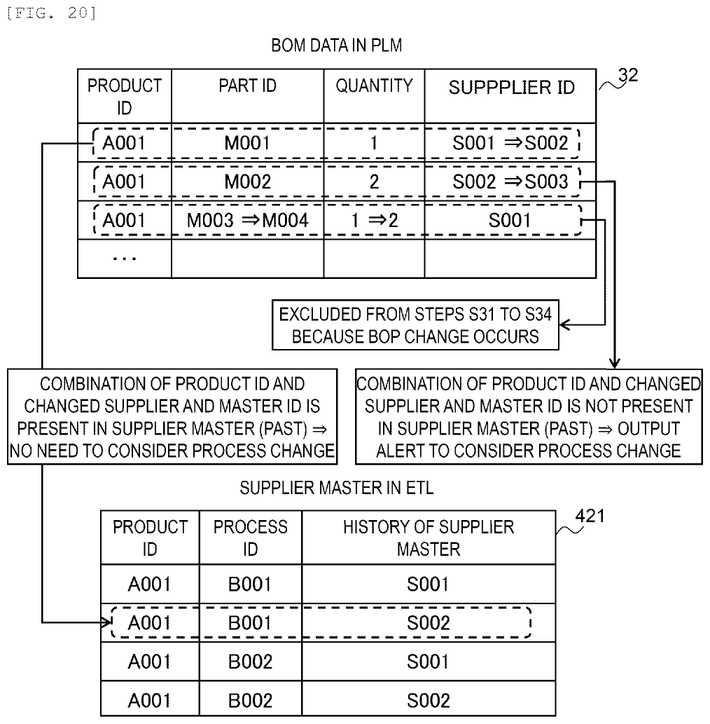

FIG. 18 is a flowchart showing a digital twin model data collection process according to the embodiment. The digital twin model data collection process is executed by the model data collection unit 42 following the change detection process (FIG. 17).

First, in step S21, the model data collection unit 42 acquires the process order master 521 from the digital twin and stores the process order master 521 in a storage area (not shown). Next, in step S22, the model data collection unit 42 acquires the process ID and 4M master 522 from the digital twin 5 and stores the process ID and 4M master 522 in a storage area (not shown).

### (Changed Part and Model Difference Determination and ETL and Digital Twin Master Update Process)

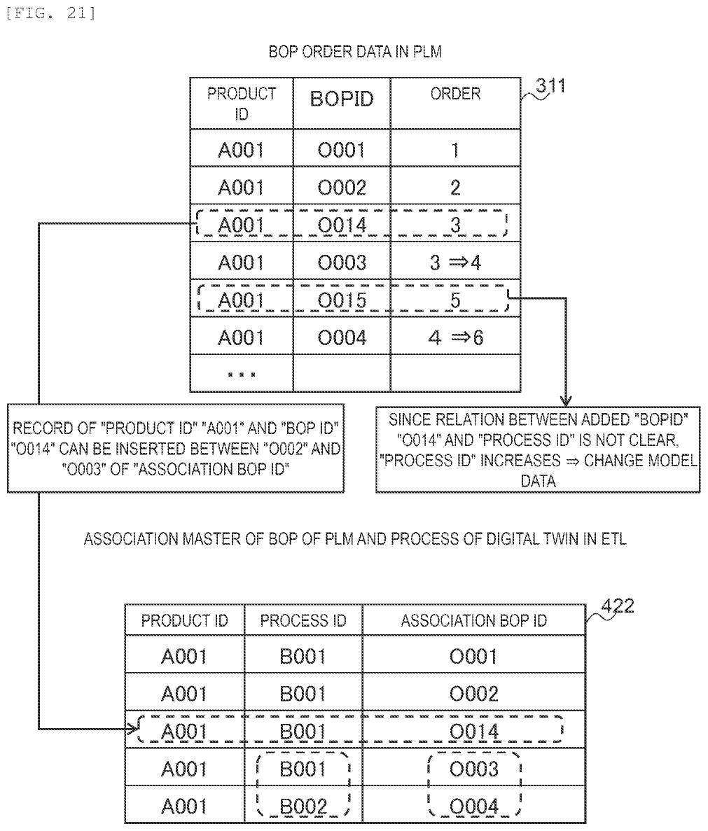

FIG. 19 is a flowchart showing a changed part and model difference determination and ETL and digital twin master update process according to the embodiment. The changed part and model difference determination and ETL and digital twin master update process is executed by the model data update unit 43 following the digital twin model data collection process (FIG. 18).

First, in step S31, the model data update unit 43 determines whether a change detected by the changed part detection unit 41 is in the BOM data 32. When the change detected is in the BOM data 32 (YES in step S31), the model data update unit 43 shifts the process to step S32. When the change detected is in the BOP data 31 (NO in step S31), the model data update unit 43 shifts the process to step S35.

In step S32, the model data update unit 43 determines whether the changed part of the BOM data 32 is the “supplier ID” related to a process from procurement to pre-manufacturing. In the present embodiment, the changed part corresponds to the process of procurement. When the changed part is the “supplier ID” (YES in step S32), the model data update unit 43 shifts the process to step S33. When the changed part is the “part or quantity” (NO in step S32), the model data update unit 43 shifts the process to step S35.

In step S33, the model data update unit 43 determines whether there is an increase in the process ID in the model data 52 (the process order master 521 and the process ID and 4M master 522) of the digital twin. “There is an increase in the process ID in the model data 52 of the digital twin” occurs when the changed BOM data 32 is not present in the supplier master 431. “The changed BOM data 32 is not present in the supplier master 431” means that a change of the BOM data 32 is not absorbable in the ETL master 43a based on an existing record of the ETL master 43a. Conversely, “the changed BOM data 32 is present in the supplier master 431” means that the change of the BOM data 32 is absorbable in the ETL master 43a based on the existing record of the ETL master 43a.

When there is an increase in the process ID in the model data 52 of the digital twin (YES in step S33), the model data update unit 43 shifts the process to step S34. When there is no increase in the process ID in the model data 52 of the digital twin (NO in step S33), the model data update unit 43 shifts the process to step S35.

In step S34, the model data update unit 43 generates an alert record for notifying the increase in the process ID and prompting a countermeasure, and adds the alert record to the alert data 44a.

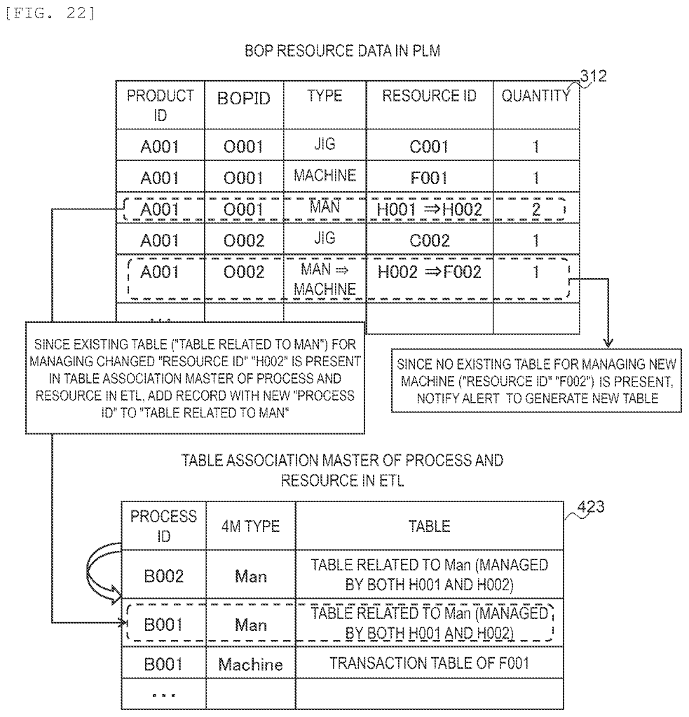

FIG. 20 is a diagram illustrating steps S32 to S34 in FIG. 19. A BOM change may be two changes, that is, a part change or a quantity change, and a supplier change. It is confirmed whether it is necessary to change a model related to a process before a manufacturing process in the digital twin. In the present embodiment, since the digital twin model related to a process before manufacturing is the supplier master 431 related to the procurement, it is confirmed whether it is necessary to change the supplier master 431 due to the BOM change.

As shown in FIG. 20, in the first row of the BOM data 32, the supplier ID is changed (YES in step S32). In the first row of the BOM data 32, the “product ID” is changed to “A001”, the “supplier ID” is changed to “S002”. Since a combination in which the “product ID” is “A001” and the “supplier ID” is “S002” is present in the second row of the supplier master 431 (NO in step S33), it is not necessary to change the model data 52 of the digital twin 5.

The supplier ID is also changed in the second row of the BOM data 32 (YES in step S32). In the second row of the BOM data 32, the “product ID” is changed to “A001”, the “supplier ID” is changed to “S003”. Since a combination in which the “product ID” is “A001” and the “supplier ID” is “S003” is not present in (the second row of) the supplier master 431 (YES in step S33), it is necessary to add the “process ID”. Therefore, an alert prompting to consider the change of the model data 52 of the digital twin 5 is generated and output to the alert data 44a (step S34).

Referring back to FIG. 19. In step S35, the model data update unit 43 determines whether a procedure of the BOP is increased (the number of records of the BOP order data 311 is increased). When the procedure of the BOP is increased (YES in step S35), the model data update unit 43 shifts the process to step S36. When the procedure of the BOP is not increased (NO in step S35), the model data update unit 43 shifts the process to step S38.

In step S36, the model data update unit 43 determines whether there is an increase in the process ID in the model of the digital twin (the association master 432 of the process of the digital twin). When there is an increase in the process ID in the model of the digital twin (YES in step S36), the model data update unit 43 shifts the process to step S37. When there is no increase in the process ID in the model of the digital twin (NO in step S36), the model data update unit 43 shifts the process to step S38.

In step S37, when a record of the process ID corresponding to a record increased in the BOP order data 311 can be added to the association master 432 of the process of the digital twin, the model data update unit 43 adds this record to the association master 432 of the process of the digital twin. On the other hand, when the record of the process ID corresponding to the record increased in the BOP order data 311 cannot be added to the association master 432 of the process of the digital twin, the model data update unit 43 adds the corresponding process ID to the model data 52 (the process order master 521 in the digital twin).

FIG. 21 is a diagram illustrating steps S35 to S37 in FIG. 19. In steps S35 to S37, when the increased procedure of the BOP in the model on the digital twin 5 is an absorbable procedure (BOP ID), the procedure is added to the ETL master 43a, when the increased procedure is not absorbable, the process proceeds to a change in the model data 52 of the digital twin.

As shown in FIG. 21, in the BOP order data 311, the third and fifth rows are added (YES in step S35). When the added “BOP ID” is absorbable in the “process ID” as the order (YES in step S36), a record is added to the association master 432 of the BOP of the PLM and the process of the digital twin in the ETL (step S37). Here, “absorbable” refers to a case in which the association master 432 of the BOP of the PLM and the process of the digital twin in the ETL is compared with the BOP order data 311, and the “BOP ID” added in the same process ID is included.

“BOP ID” “O014” in the third row can be inserted as “process ID” “B001” between “O002” and “O003” of the “association BOP ID” with the “product ID” as “A001” in the association master 432 of the BOP of the PLM and the process of the digital twin in the ETL.

On the other hand, the “association BOP ID”, “O002” and “O003” of the “product ID” “A001” in the association master 432 of the BOP of the PLM and the process of the digital twin are different in “process ID” “B001” and “B002”, and the relation between the “BOP ID” and the “process ID” is not clear. Therefore, “BOP ID” “O015” in the fifth row cannot be inserted between “association BOP ID”, “O002” and “O003” of the “product ID” “A001”. Therefore, the “process ID” corresponding to the “BOP ID” “O015” in the fifth row is added to the model data 52 (the process order master 521 in the digital twin).

Referring back to FIG. 19. In step S38, the model data update unit 43 determines whether an existing table for managing the changed resource is present in the table association master 433 of a process and a resource in the ETL. When an existing table is present (YES in step S38), the model data update unit 43 shifts the process to step S39. When no existing table is present (NO in step S38), the model data update unit 43 shifts the process to step S40.

In step S39, the model data update unit 43 copies a record related to the changed resource, assigns a new “process ID”, and registers the record in the table association master 433 of the process and the resource in the ETL.

On the other hand, in step S40, the model data update unit 43 changes the model data (the process ID and 4M master 522) of the digital twin. Specifically, a record of a new “process ID” is generated in the process ID and 4M master 522, and “True (corresponding)” or “False (not corresponding)” is stored in a column of a resource type (Man, Machine) after the change. Next, in step S41, since no table for managing a resource having a new “resource type” and a “resource ID” is present, the model data update unit 43 generates a data item, generates an alert for notifying the necessity of generating a new table on the table item, and adds the generated alert to the alert data 44a.

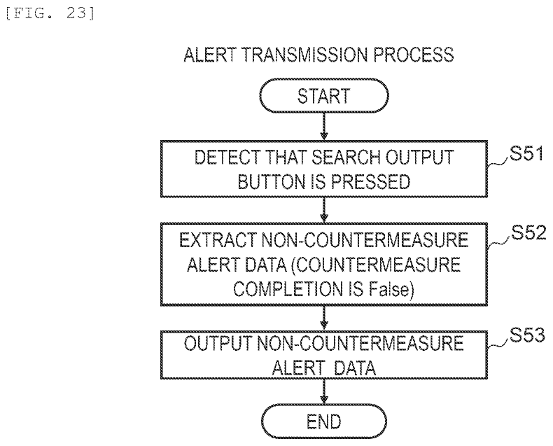

FIG. 22 is a diagram illustrating steps S38 to S41 in FIG. 19. In steps S38 to S41, when a table for managing a resource absorbable in a business model is present in the digital twin, this table and a new “process ID” are associated and absorbed, and when no table is present, an alert is output to generate a new table.

As shown in FIG. 22, resources in the third and fifth rows in the BOP resource data 312 are changed. When the changed resources are absorbable (YES in step S38), a record is added to the table association master 433 of the process and the resource in the ETL (step S39). The “absorbable” means that a table for managing the changed resource is described in the table association master 433 of the process and the resource in the ETL.

A resource with the “type” as “man” and the “resource ID” as “H002” in the third row after the resource change is managed by a “table related to Man”, which is a “table” with the “process ID” as “B002” in the table association master 433 of the process and the resource in the ETL (YES in step S38). Therefore, a record in the first row in the table association master 433 of the process and the resource in the ETL is copied, and a new record with the “process ID” as “B001” is added (step S39).

On the other hand, a table for managing a resource with the “type” as “machine” and the “resource ID” as “F002” in the fifth row after the resource change is not described in the table association master 433 of the process and the resource in the ETL (NO in step S38). Therefore, the model data 52 of the digital twin 5 is changed (step S40), and an alert for notifying the necessity of generating a table for managing a resource with the “resource type” as “machine” and the “resource ID” as “F002” is generated and added to the alert data 44a (step S41).

### (Alert Transmission Process)

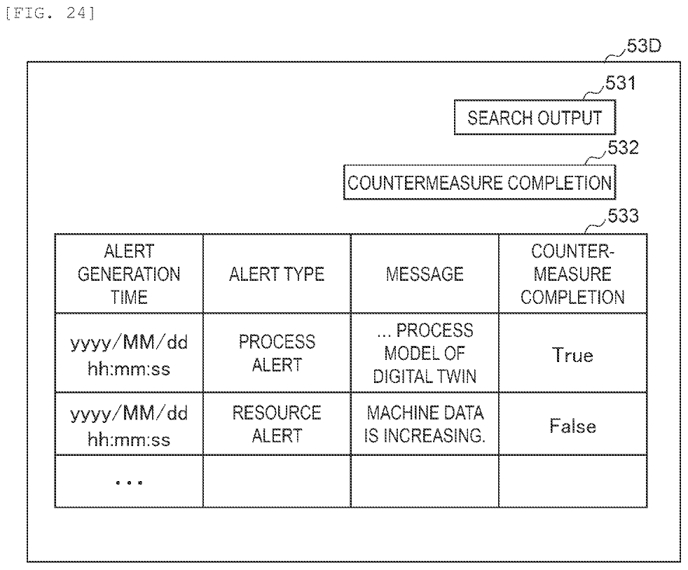

FIG. 23 is a flowchart showing an alert transmission process according to the embodiment. FIG. 24 is a diagram showing the user interface 53D according to the embodiment. The alert transmission process is executed by the alert output unit 44 in response to a user instruction.

First, in step S51, the alert output unit 44 detects that a search output button 531 on the user interface 53D displayed on the UI unit 53 of the digital twin 5 is pressed. Next, in step S52, the alert output unit 44 searches the alert data 44a, and extracts non-countermeasure data in which a value of “False” is stored in a column of “countermeasure completion”. Next, in step S53, the alert output unit 44 displays, in a display region 533, the non-countermeasure data extracted in step S52. When a countermeasure completion button 532 indicating that a measure against a content indicated by an alert is taken by the user is pressed, a value in the column of “countermeasure completion” of the corresponding alert data 44a is updated to “True”.

### (Data Input Process)

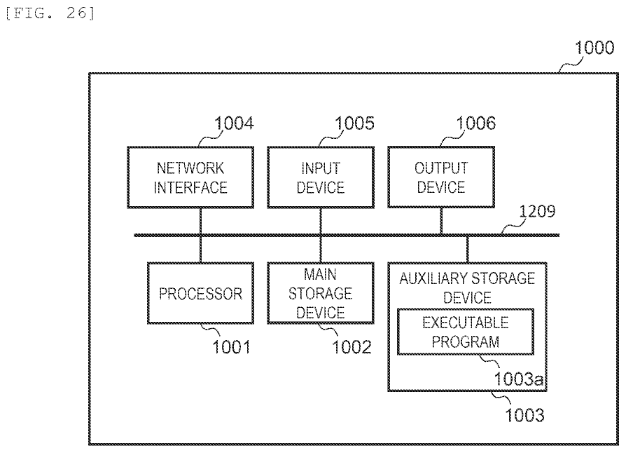

FIG. 25 is a flowchart showing a data input process according to the embodiment. The data input process is executed by the data input unit 45 at a predetermined cycle or in response to user designation.

First, in step S61, the data input unit 45 acquires the “operation instruction ID” for each “product consistency ID” from the operation instruction data 24. Next, in step S62, the data input unit 45 acquires, from the operator transaction data 22 and the machine transaction data 23, a record associated with the “operation instruction ID” acquired in step S61.

Next, in step S63, the data input unit 45 refers to the operation instruction data 24, acquires a “BOP ID” associated with the “operation instruction ID” acquired in step S61, and extracts a record having the “BOP ID” from the association master 432 of the BOP of the PLM and the process of the digital twin in the ETL. Then, the data input unit 45 specifies the “process ID” of the extracted record. That is, the data input unit 45 determines the “process ID” corresponding to the model of the digital twin from the “BOP ID” associated with the “operation instruction ID”.

Next, in step S64, the data input unit 45 adds the “process ID” to items of the “product consistency ID” and the “completion result” of the operation instruction data 24 having the “operation instruction ID” corresponding to the “process ID” specified in step S63, and adds the “process ID” to the transaction data 511 for each product and process of the digital twin 5.

Next, in step S65, the data input unit 45 adds, to the transaction data 51 of the digital twin 5, the operator transaction data 22 and the machine transaction data 23 having the “operation instruction ID” corresponding to the “process ID” specified in step S63.

### Effects of Embodiment

In the above-described embodiment, the ETL 4 updates the ETL master 43a or the model data 52 of the digital twin 5 based on a change in accordance with whether the change of the BOP data 31 or the BOM data 32 included in the PLM 3 is absorbable in the ETL master 43a for data conversion when result data 20 is input to the digital twin 5. Therefore, since data of the digital twin 5 is automatically updated, it is possible to reduce the number of man-hours for constructing and updating the digital twin 5.

In the above-described embodiment, when a change in BOP data 31 or BOM data 32 occurs with a transition of time and place, the ETL 4 determines whether a change in model data of the digital twin 5 occurs, and automatically changes a model of the ETL master 43a. Therefore, it is possible to grasp an influence range of the change of the BOP data 31 or the BOM data 32, and to efficiently construct and update the digital twin 5 without wasting man-hours.

In the above-described embodiment, the ETL 4 cooperates with the MES 2/ERP, the PLM 3, and the digital twin 5. Therefore, the ETL 4 cannot only manufacture but also construct a model of the digital twin 5 including the entire supply chain based on the change of the BOP data 31 or the BOM data 32, and can perform automatic cooperation.

### (Hardware of Computer 1000)

FIG. 26 is a hardware diagram showing a configuration example of a computer 1000. For example, the MES 2, the PLM 3, the ETL 4, the digital twin 5, or a system in which these systems are appropriately integrated is implemented by the computer 1000.

The computer 1000 includes a processor 1001 including a CPU, a main storage device 1002, an auxiliary storage device 1003, a network interface 1004, an input device 1005, and an output device 1006 that are connected to one another via an internal communication line 1009 such as a bus.

The processor 1001 controls the overall operation of the computer 1000. The main storage device 1002 includes, for example, a volatile semiconductor memory, and is used as a work memory of the processor 1001. The auxiliary storage device 1003 includes a large-capacity nonvolatile storage device such as a hard disk device, a solid state drive (SSD), or a flash memory, and is used to store various programs and data for a long period of time.

An executable program 1003a stored in the auxiliary storage device 1003 is loaded into the main storage device 1002 when the computer 1000 is started or when necessary, and the processor 1001 executes the executable program 1003a loaded in the main storage device 1002, thereby implementing systems that execute various processes.

The executable program 1003a may be recorded in a non-transitory recording medium, read from the non-transitory recording medium by a medium reading device, and loaded into the main storage device 1002. Alternatively, the executable program 1003a may be acquired from an external computer via a network and loaded into the main storage device 1002.

The network interface 1004 is an interface device for connecting the computer 1000 to each network in the systems or communicating with other computers. The network interface 1004 includes, for example, a network interface card (NIC) of a wired local area network (LAN) or a wireless LAN.

The input device 1005 includes a keyboard or a pointing device such as a mouse, and is used by the user to input various instructions and information to the computer 1000. The output device 1006 includes, for example, a display device such as a liquid crystal display or an organic electro luminescence (EL) display, or a sound output device such as a speaker, and is used to present necessary information to the user when necessary.

The technique of the present disclosure is not limited to the above-described embodiment, and includes various modifications. For example, the embodiment described above is described in detail for easy understanding of the technique of the present application, and is not necessarily limited to those having all the configurations described above. A part of a configuration of one embodiment may be replaced with a configuration of another embodiment, and a part or all of configurations of some embodiments may be added to a part or all of configurations of another embodiment within the range not being contradictory to each other. A part of a configuration of each embodiment can be added, deleted, replaced, integrated, or distributed with respect to the configuration. The configuration and the process described in the embodiment can be appropriately distributed, integrated, or replaced based on processing efficiency or mounting efficiency.

### REFERENCE SIGNS LIST

1 overall system
2 MES
3 PLM
4 ETL
5 digital twin
20 result data
31 BOP data
32 BOP data
41 changed part detection unit
42 model data collection unit
43 model data update unit
43a ETL master
44 alert output unit
44a alert data
45 data input unit
51 transaction data
52 model data
53 UI unit
53D user interface

1. A digital twin cooperation method executed by a digital twin cooperation system that causes a business system related to production including product manufacturing to cooperate with a digital twin for simulating the production based on transaction data and model data,
the digital twin cooperation system including master data of the digital twin, the method comprising:
a data input step of converting result data related to the production acquired from the business system into the transaction data using the master data and inputting the transaction data into the digital twin;
a change detection step of detecting a change in manufacturing information related to the product manufacturing that the business system has;
a determination step of determining whether the change is absorbable in the master data based on an existing record of the master data; and
an update step of updating the master data or the model data based on the change according to a determination result of the determination step.

2. The digital twin cooperation method according to claim 1, wherein
in the data input step,
the result data acquired from a manufacturing execution system (MES) or a system that performs enterprise resources planning (ERP) in the business system is converted into the transaction data using the master data, and the transaction data is input into the digital twin, and
in the change detection step,
a change in bill of material (BOM) or bill of process (BOP), which is the manufacturing information of a system that performs product life management (PLM) in the business system, is detected.

3. The digital twin cooperation method according to claim 2, wherein
in the determination step,
whether the change is a change in supplier related to a predetermined process of the BOM is determined, and
whether the changed supplier is present in the existing record of the master data is determined, and
in the update step,
the master data is not updated when the changed supplier is present in the existing record of the master data.

4. The digital twin cooperation method according to claim 3, further comprising:
an alert generation step of generating, when the changed supplier is not present in the existing record of the master data, an alert prompting addition of a process to the model data according to the change in supplier; and
an output step of outputting, via a user interface, the alert generated in the alert generation step.

5. The digital twin cooperation method according to claim 2, wherein
in the determination step,
whether the change is an increase in procedure of the BOP is determined, and
whether the increased procedure of the BOP is insertable into the existing record of the master data is determined, and
in the update step,
when the increased procedure of the BOP is insertable into the existing record of the master data, the increased procedure of the BOP is inserted into the master data, and when the increased procedure of the BOP is not insertable into a existing record of the master data, a new process ID is added to the model data according to the increase in procedure of the BOP.

6. The digital twin cooperation method according to claim 2, wherein
in the determination step,
whether the change is a change in resource of the BOP is determined, and
whether a table for managing the changed resource is present and described in the existing record of the master data is determined, and
in the update step,
when the table is described in the existing record of the master data, the existing record is copied, assigned with a new process ID, and inserted into the master data.

7. The digital twin cooperation method according to claim 6, further comprising:
an alert generation step of generating, when the table is not described in the existing record of the master data, an alert prompting generation of the table; and
an output step of outputting, via a user interface, the alert generated in the alert generation step.

8. A digital twin cooperation system that causes a business system related to production including product manufacturing to cooperate with a digital twin for simulating the production based on transaction data and model data, the digital twin cooperation system comprising:
a storage unit configured to store master data of the digital twin;
a data input unit configured to convert result data related to the production acquired from the business system into the transaction data using the master data and input the transaction data into the digital twin;
a change detection unit configured to detect a change in manufacturing information related to the product manufacturing that the business system has; and
an update unit configured to determine whether the change is absorbable in the master data based on an existing record of the master data and update the master data or the model data based on the change according to a determination result.

9. The digital twin cooperation system according to claim 8, wherein
the data input unit converts the result data acquired from a manufacturing execution system (MES) or a system that performs an enterprise resources planning (ERP) in the business system into the transaction data using the master data, and inputs the transaction data into the digital twin, and
the change detection unit detects a change in bill of material (BOM) or bill of process (BOP), which is the manufacturing information of a system that performs product life management (PLM) in the business system.

10. The digital twin cooperation system according to claim 9, wherein
the update unit
determines whether the change is a change in supplier related to a predetermined process of the BOM,
determines whether the changed supplier is present in the existing record of the master data, and
does not update the master data when the changed supplier is present in the existing record of the master data.

11. The digital twin cooperation system according to claim 10, wherein
the update unit generates, when the changed supplier is not present in the existing record of the master data, an alert prompting addition of a process to the model data according to the change in supplier, and
an output unit configured to output, via a user interface, the alert generated by the update unit is included.

12. The digital twin cooperation system according to claim 9, wherein
the update unit
determines whether the change is an increase in procedure of the BOP,
determines whether the increased procedure of the BOP is insertable into the existing record of the master data,
inserts, when the increased procedure of the BOP is insertable into the existing record of the master data, the increased procedure of the BOP into the master data, and adds, when the increased procedure of the BOP is not insertable into a existing record of the master data, a new process ID to the model data according to the increase in procedure of the BOP.

13. The digital twin cooperation system according to claim 9, wherein
the update unit
determines whether the change is a change in resource of the BOP,
determines whether a table for managing the changed resource is present and described in the existing record of the master data, and
when the table is described in the existing record of the master data, copies the existing record, assigns a new process ID, and inserts the copied record into the master data.

14. The digital twin cooperation system according to claim 13, wherein
the update unit generates, when the table is not described in the existing record of the master data, an alert prompting generation of the table, and
an output unit configured to output, via a user interface, the alert generated by the update unit is included.

15. A digital twin cooperation program for causing a computer to function as the digital twin cooperation system according to claim 8.
